(19) United States
(12) Patent Application Publication
(10) Pub. No.: US 2022/0280886 A1
(43) Pub. Date: Sep. 8, 2022

(54) Method in Bioprocess Purification System

(71) Applicant: Cytiva Sweden AB, Uppsala (SE)

(72) Inventors: Gunnar Malmquist, Uppsala (SE); Ola Lind, Uppsala (SE); Matthew Townsend, Uppsala (SE); Ian Scanlon, Uppsala (SE); Zachary Michael Sexton, Uppsala (SE)

(21) Appl. No.: 17/619,204

(22) PCT Filed: Jun. 16, 2020
(86) PCT No.: PCT/EP2020/066639

§ 371 Date: Dec. 14, 2021

(30) Foreign Application Priority Data
Jun. 27, 2019 (GB) 1909274.1

(51) Int. Cl. B01D 15/18; G01N 30/86

(52) U.S. Cl. CPC B01D 15/1885; B01D 15/1814; G01N 30/8658

(57) ABSTRACT

The present invention relates to a method for monitoring operational status in a column capture chromatography system configured for cyclical repetitive purification performed on a volume of sample feed comprising at least one product configured to be captured in the column during loading. The method comprises: performing (51) a purification cycle; measuring (52) at least one parameter during the purification cycle indicative of breakthrough of the at least one captured product after the column during loading of sample feed; when breakthrough is detected, reducing (56a) the amount of sample feed loaded during loading in the next purification cycle; and repeating the steps to perform another purification cycle. Each purification cycle comprising: loading an amount of sample feed onto the column, washing the column and eluting the at least one product.

### TECHNICAL FIELD

The present invention relates to a method for monitoring and controlling a bioprocess purification system for cyclical repetitive purification of at least one product in a bioreactor system.

### BACKGROUND

The quality of the material produced in the bioreactor (in cell culture system) is important in order to achieve a reliable, robust and economic manufacturing procedure when purifying the harvest from a bioreactor.

Currently, the clarified or clear feed from the bioreactor is introduced into a column capture chromatography system configured for a cyclic purifying process to extract the product. The cyclic process includes: loading the feed onto a column, washing the column, eluting the product and thereafter cleaning the column before the column is loaded with new feed in a repetitive manner. For a given volume of feed, the purification process using small volume columns will be more time consuming than when using large volume columns.

Thus, there is a need to modify the purification process to achieve a more efficient cyclic process especially for small volume columns in purification using a column capture chromatography system for a given volume of feed.

### SUMMARY

An object of the present disclosure is to provide methods and devices configured to execute methods and computer programs which seek to mitigate, alleviate, or eliminate one or more of the above-identified deficiencies in the art and disadvantages singly or in any combination.

The object is achieved by a method as defined by the independent claims.

An advantage is that the time to perform the purification of a product may be reduced while maintaining a high yield.

Another advantage is that the purification process may be adapted to more efficiently use available capacity in the chromatography system.

Further objects and advantages may be obtained from the detailed description by a skilled person in the art.

### BRIEF DESCRIPTION OF THE DRAWINGS

FIG. 1 illustrates an overview of a bioprocess purification system designed to purify a product from a harvest fluid from a bioreactor.

FIG. 2 illustrates the concept of controlling upstream/downstream processes in a bioprocess purification system.

FIG. 3a illustrates an ideal cyclic capture chromatography process configured to deliver a product from a sample feed using only one column.

FIG. 3b illustrates a cyclic capture chromatography process using several columns in sequence.

FIG. 4 is a graph illustrating pressure behaviour in a cyclic capture chromatography process.

FIG. 5 illustrates a first embodiment of a process for monitoring operational status in a single column capture chromatography system.

FIG. 6 illustrates a second embodiment of a process for monitoring operational status in a single column capture chromatography system.

FIG. 7 illustrates a third embodiment of a process for monitoring operational status in a single column capture chromatography system.

### DETAILED DESCRIPTION

A bioprocess purification system is designed for production and purification of products (such as proteins, biomolecules from cell culture/fermentation, natural extracts) by growing cells capable of expressing the product in a cell culture bioreactor followed by a downstream purification process (also referred to as Downstream process) for purifying the product. The downstream purification process may be any suitable process capable of providing a purified product, the process may comprise one or multiple steps. One commonly used step in a downstream purification process is chromatography. In particular the current invention relates to a bioprocess purification system arranged to produce and provide a purified product during an extended period of time from a volume of sample feed. The product is provided as a batch with a volume larger than the volume of the column, or the product is harvested from the bioreactor and purified by the downstream purification process while the cell culture is maintained. This type of cell culture is herein referred to as “continuous cell culture process” and examples of such cell cultures includes perfusion cell culture and chemostat cell culture.

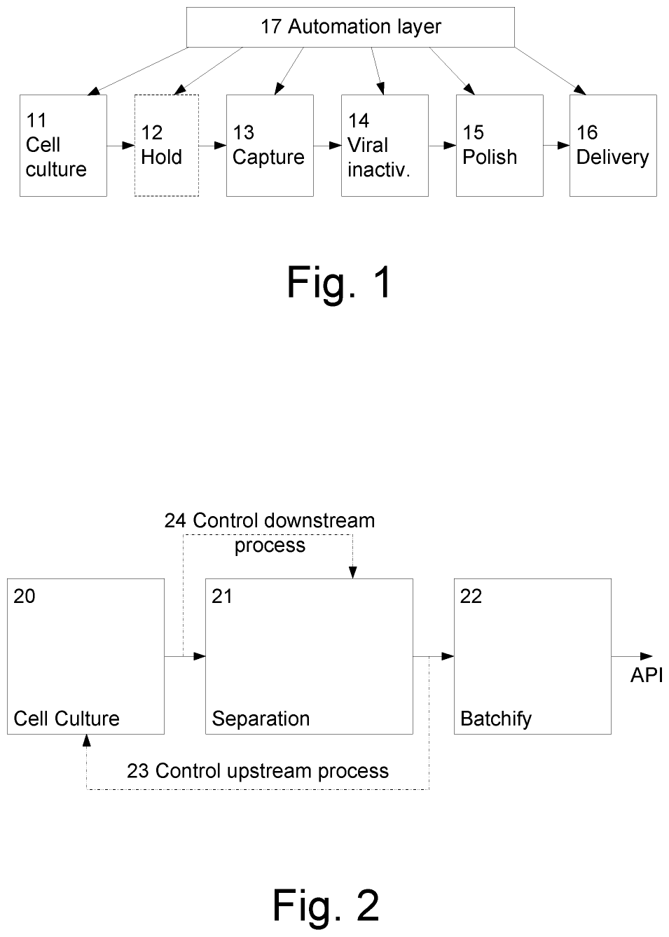

In FIG. 1, an overview of a bioprocess purification system according to one embodiment, configured to purify a product using a separation process is shown. The bioprocess purification system comprises a number of steps related to Cell culture 11, Hold 12, Capture 13, Viral inactivation 14, Polish 15 and Delivery 16.

In one of the disclosed embodiments of the present invention the cell culture step 11 may be a continuous cell culture process which comprises of continuous addition of nutrients and continuous removal of product and waste over an extended period of time (harvest). The process can either be operated in perfusion retaining the cells in the bioreactor by e.g. using an Alternate Tangential Filtration (ATF) device. Alternatively, the bioreactor is operated without cell retention, i.e. a chemostat. The cell culture step may comprise process control for viable cell density, VCD, but also nutrients and metabolites. The VCD, productivity and product quality may be controlled by adapting the components of the cell culture media fed to the culture or by addition of certain components directly to the culture, as described in more detail below.

In some embodiments, the harvest containing the product may be clarified before feeding the harvest to the downstream purification process, e.g. by filtration, centrifugation or another technique.

The hold step 12 is an optional step depending on process needs, e.g. if a filter is in-line before capture step 13. The step may comprise process control on weight, and the next step in the process starts when a pre-determined volume value is reached, or alternatively after a certain time period or when a pre-determined mass is reached. The hold step may be used for collecting a volume of filtered feed from a perfusion cell culture.

In another embodiment of the present invention, the cell culture step is omitted and a batch of sample feed containing the product is provided in the hold step 12 and provided to the purification process.

In the disclosed embodiment, the downstream purification process comprises three steps Capture 13, Viral inactivation 14 and Polish 15. The capture step 13 may comprise a chromatography process in a single chromatography column. A filter may be provided in-line before the capture step. The capture step comprises multiple batch elutions, and process control e.g. using in-line UV-sensors handles variation in feed concentration and resin capacity. The next step starts when a pre-determined amount value (e.g. volume, mass or time) is reached.

In the viral inactivation step 14, different options for virus inactivation is available depending on process needs. One option is to use batch mode with low pH for 30-60 minutes in a hold up tank. The step may comprise process control on volume, time, temperature and pH. The next step starts when a pre-determined time is reached.

The polish step 15 may be straight through processing (STP) with a connected batch step or continuous chromatography with a continuous load step, or a combination thereof. The flow rate is adjusted to perfusion rate required by producer cells, which means that the flow rate is determined by the preceding step. The step may comprise process control for UV, flow and volume, and the next step starts when a pre-determined volume and amount is reached, alternatively when a timeout is reached.

The delivery step 16 may comprise a virus removal step, e.g. a viral filter, before an ultra-filtration step. The delivery step may be used as concentration step for batch addition of processed harvest from polish step. The delivery step 16 may comprise continuous or batch delivery of product and may comprise continuous or batch removal of waste. The step may comprise process control for pH, conductivity, absorbance, volume and pressure, and delivery is achieved when a pre-determined product concentration in a pre-defined environment is reached.

An automation layer 17 is used for handling decision points for next step in the process. Different type of sensors (not shown), both in-line sensors and off-line sensors, are integrated into the process flow to monitor different parameters that may be used for providing the automation layer 17 with data that could be used to handle the decision points. Sensors include but are not limited to only measure flow, VCD, weight, pressure, UV, volume, pH, conductivity, absorbance, etc.

It should be noted that UV absorption is an example of a parameter that could be monitored to detect the composition of the harvest being purified. However, other parameters may be used operating in other frequency ranges, such as IR, fluorescence, x-rays, etc.

The product quality of the product produced in a bioprocess purification system may be improved by obtaining information related to the product during the process run, or the produced product itself. Attributes relevant to product quality have to be measured, and different analytic methods may be used such as Mass Spectroscopy, MS, Light Scattering, Size Exclusion Chrom, SEC, Raman spectroscopy, etc.

The cell culture system comprises a bioreactor that produces a harvest containing the product and the cell culture process may be controlled to optimize the product quality of the product. Examples of parameters that may be controlled in the bioreactor is temperature, aeration, agitation etc.

FIG. 2 illustrates the concept of controlling upstream/downstream processes in a bioprocess purification system. The illustration of the bioprocess purification system is simplified and comprises three steps: Sample Feed 20, Separation 21 and batchify 22. The product (in this example exemplified by “active pharmaceutical ingredient”—API) is delivered after the batchify step.

The Sample feed 20 may be a Cell culture step in a continuous cell culture process as described above that includes continuous addition of nutrients to e.g. a cell perfusion process with continuous harvest of product and waste, or a batch of sample feed provided in a volume larger than the capacity of the single column chromatography system. The sample feed, comprising product and waste, is considered to be the harvest that is fed into the Separation step 21 which may include one or more steps of a downstream purification process. The separation step comprises a process for at least partly separating the product from the waste in the harvest and the product is forwarded to the final step Batchify 22, in which the product is handled to be ready for delivery as API.

After the separation step, certain parameters, or quality attributes, may be measured, e.g. composition of impurities in product or amount of fragments or aggregates of the product using mass spectrometer, MS, or spectrometry. This information may be used to control an upstream process 23. For instance, if a high amount of degraded product is detected after separation, this may be counteracted by changing parameters in the cell culture step, e.g. by an increased flow rate of medium into the bioreactor to prevent degradation of product molecules before introduced into the separation step 21. Alternatively, feeding of nutrients or process parameters in the cell culture may be adjusted based on the measured quality attributes, as described in more detail below. Variations in composition of the sample feed that is provided to the separation step 21, may be detected after the column, e.g. if breakthrough of the captured product is detected, which may be counteracted by changing the amount of sample feed loaded onto the column.

The same concept may be used to control a downstream process 24. The concentration of product in the harvest being fed into the separation step 21 may be determined by measuring the time to load each column and the peak amount of product after elution. This information may be used to adjust the elution based on the concentration of product in the harvest being fed into the separation step.

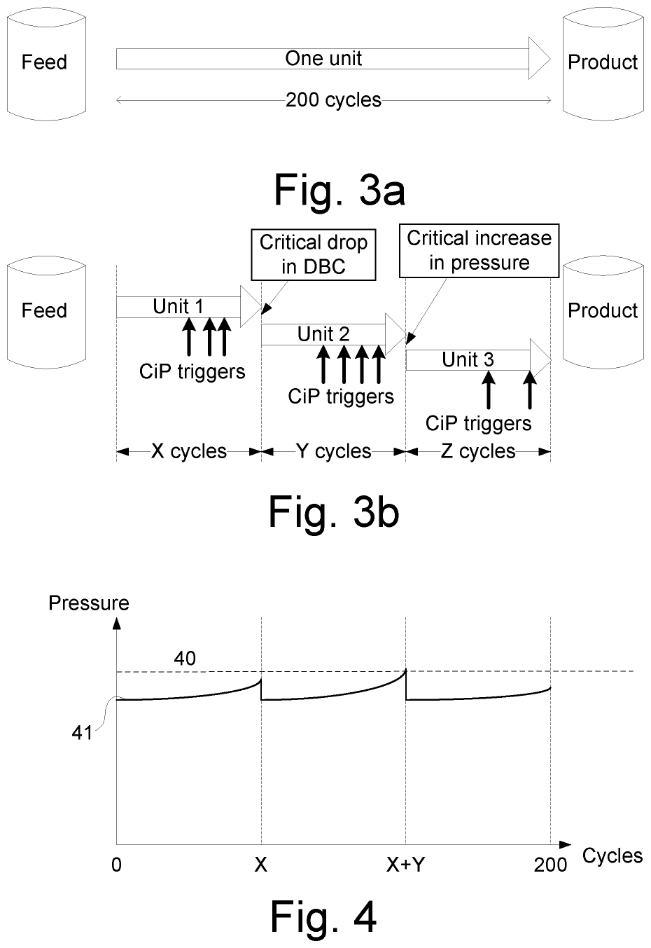

FIG. 3a illustrates an ideal cyclic capture chromatography process configured to deliver at least one product from a volume of sample feed using only one column with a cyclical repetitive purification process. In this example the same column is used over 200 cycles, wherein each purification cycle comprises loading an amount of sample feed onto the column, washing the column and eluting the at least one captured product. However, this is not the case since the performance of the system deteriorate as a function of cycles performed, and when the performance is decreased, the column needs to be cleaned using a Cleaning-in-place, CIP, which improves the performance of the chromatography column. Also, when the performance of the column is not improved by the CIP, the column needs to be replaced by a new column. This process is illustrated in FIG. 3b.

FIG. 3b illustrates a cyclic capture chromatography process using several columns in sequence. CIP triggers are indicated, and a CIP is performed on the column as a result. CIP triggers may be any of the following:
If pressure during loading of sample feed increases by 10%
If elution peak width during elution increases, e.g. by >5%
If elution peak asymmetry increases

CIP will improve the performance of the system to a certain level before the column has to be replaced. Below are some examples of indications that may be used to determine when a column needs to be replaced:
If pressure during loading of sample feed increases beyond a safe limit (as indicated by the dash-dot line 40 in FIG. 4)
If amount of sample feed drops below 70% of Dynamic Binding Capacity, DBC, of the resin in the column
If no improvement within 3 cycle runs after a CIP initiated by an increased elution peak width or elution peak asymmetry

In FIG. 3b, a CIP is performed in response to the CIP triggers, and the first column “Unit 1” is replaced by a new column “Unit 2” when a critical drop in DBC is detected. Furthermore, although several CIP are performed on Unit 2, a critical increase in pressure is detected and “Unit 2” is replaced by “Unit 3”. The final amount of product is produced using Unit 3.

FIG. 4 is a graph illustrating a pressure curve 41 for the sequentially used columns denoted “Unit 1”, “Unit 2” and “Unit 3”. After X cycles, e.g. 70 cycles, a critical drop in DBC is detected and the column is replaced. The pressure curve 41 is still below the dash-dotted line 40, indicating a safe limit for the pressure, at this point. However, when the purification commences for Y more cycles, e.g. additional 65 cycles, the pressure increases beyond the safe limit and “Unit 2” is replaced by “Unit 3” after X+Y cycles (in this example 135 cycles). After an additional Z cycles (in this example 65 cycles), the process is completed, and the final amount of product is produced after 200 cycles.

The shape of the pressure curve may be used to identify trends, and thereby more efficiently detect deteriorating performance of a column.

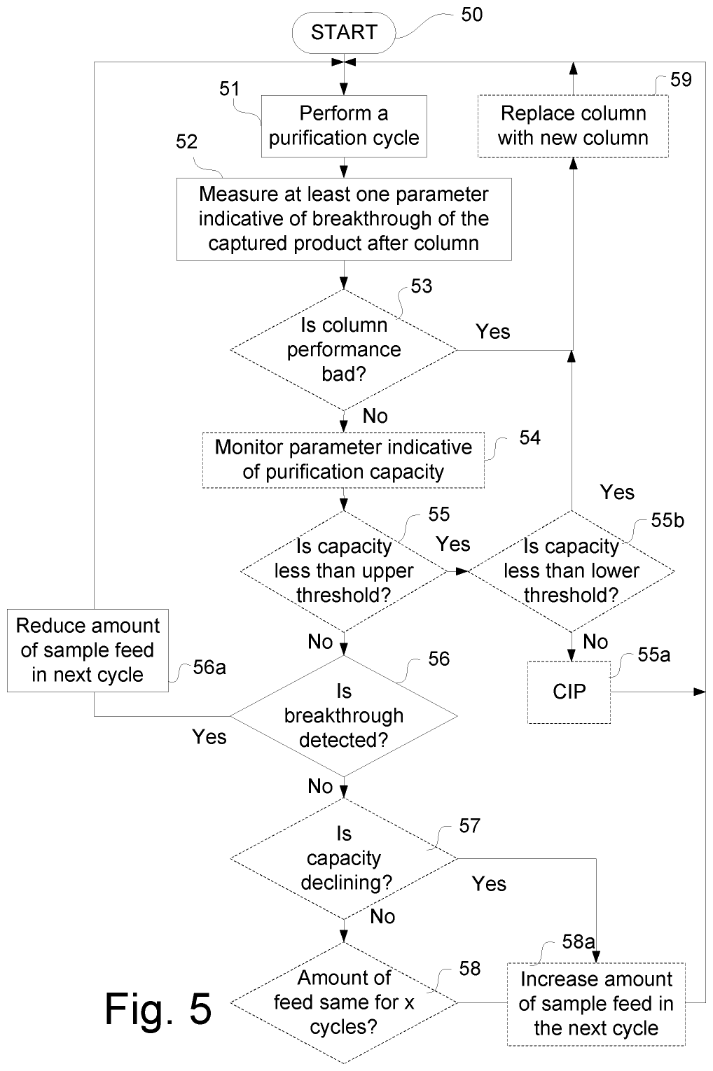

FIG. 5 illustrates a first aspect of a method 50 for monitoring operational status in a column capture chromatography system configured for cyclical repetitive purification performed on a volume of sample feed comprising at least one product, e.g. a target product, configured to be captured in the column during loading. The volume of sample feed originates from the same feed, e.g. a batch or a continuous feed. The capture chromatography system comprises one single column, or alternatively several columns coupled in parallel, to which a bio reactor may be connected being configured to provide a volume of sample feed to the column, wherein the volume of sample feed is larger than the volume capacity of the capture chromatography system. Thus requiring a cyclic purification in a repetitive manner. The process comprises a number of steps:
a) performing 51 a purification cycle comprising: loading an amount of sample feed onto the column, washing the column and eluting the captured product,
b) measuring 52 at least one parameter during the purification cycle indicative of breakthrough of the at least one captured product after the column during loading of sample feed;
c) reducing 56a the amount of sample feed loaded during loading in the next purification cycle if breakthrough of the at least one captured product is detected, as illustrated by 56; and
d) repeating steps a)-d) until the desired amount of product has been produced. This has been illustrated in connection with FIGS. 3a and 3b above.

According to some embodiments, the loading of the sample in 51 is performed during a loading time, Δt; and the loading time is reduced in 56a to reduce the amount of sample feed loaded to prevent break through during the next purification cycle. According to some embodiments the loading time is reduced at least 5%. In some embodiments, the loading time is reduced not more than 10% when break through is detected.

According to some embodiments, the loading time is increased 58a to increase the amount of sample feed loaded during the next purification cycle when the amount of sample feed is maintained in step c) during a predetermined number of consecutive purification cycles, x, as illustrated by 58. As an example x is at least 25 cycles. According to some embodiments, the loading time is increased by 1% to hit optimum loading without risking a yield loss.

According to some embodiments, the measured at least one parameter in 52 is a signal from a UV detector mounted after the column.

According to some embodiments, the method further comprises monitoring at least one additional parameter measured during elution of the at least one captured product, as illustrated by 54. The at least one additional parameter is indicative of purification capacity of the column and the method further comprises increasing, as illustrated by 58a, the amount of sample feed loaded during loading in the next purification cycle if the purification capacity is declining without an indication of breakthrough, as illustrated by 57. According to some embodiment, the amount of sample feed is increased by 1%.

According to some embodiments, the method further comprises prior to 56 evaluating 54 the at least one additional parameter measured during elution of the captured product indicative of purification capacity in the chromatography system; and cleaning 55a the column, e.g. using CIP, if the purification capacity is below an upper predetermined threshold, as indicated by 55. For example, the upper threshold corresponds to a level when the at least one additional parameter indicates a drop of 5-10% of purification capacity.

CIP will improve the performance of the system to a certain level before the column has to be replaced. According to some embodiments the column performance is monitored in step 53 and if a bad performance is detected the column needs to be replaced.

As mentioned before, below are some examples of indications that may be used to determine when a
If pressure during loading of sample feed increases beyond a safe limit (as indicated by the dash-dot line 40 in FIG. 4)
If amount of sample feed drops below 70% of Dynamic Binding Capacity, DBC, of the resin in the column
If no improvement within 3 cycle runs after a CIP initiated by an increased elution peak width or elution peak asymmetry

According to some embodiments, the evaluation in step 54 is a trend analysis of the measured at least one additional parameter over time.

According to some embodiments, the additional parameter in step 54 is an elution peak area measured when eluting the at least one captured product in relation to amount of sample feed loaded onto the column.

According to some embodiments, the step of evaluating the at least one additional parameter further comprises replacing 59 the column with a new column if the purification capacity is below a lower predetermined threshold, as indicated by 55b while breakthrough is detected. For example, the lower threshold corresponds to a level when the at least one additional parameter indicates a drop of 10-20% of purification capacity.

The invention also relates to a capture chromatography system comprising a column configured for purification performed on a sample feed comprising at least one product configured to be captured in the column during loading and a control unit configured to control purification in the column, wherein the control unit is further configured to perform the method described in connection with FIG. 5.

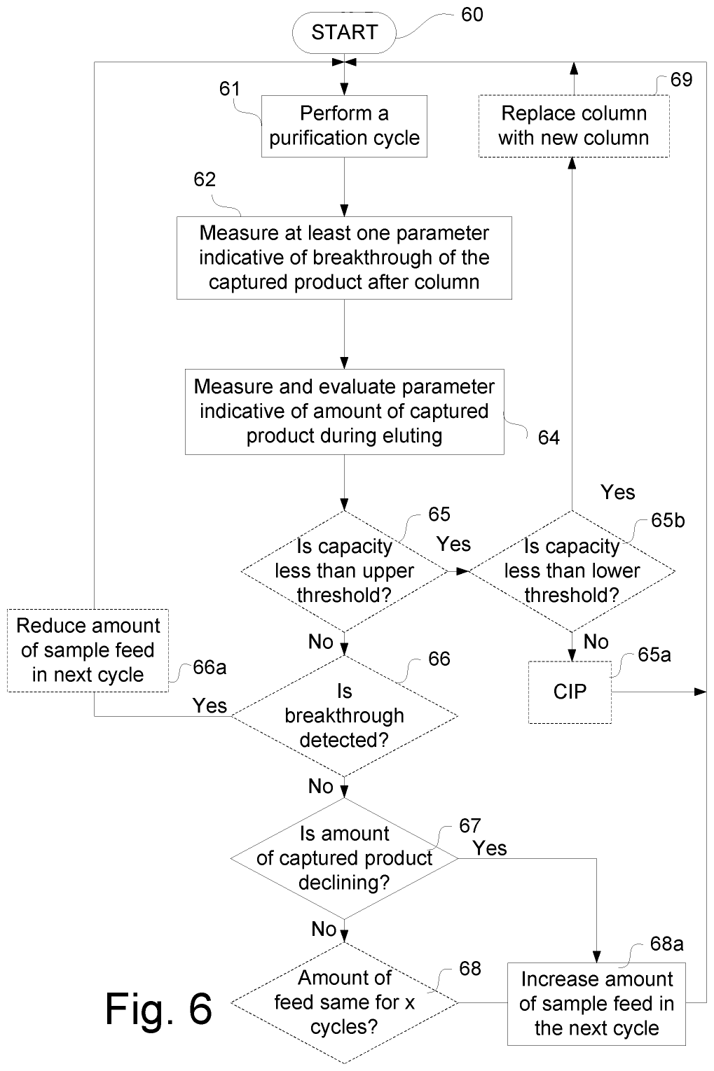

In FIG. 6 a method according to a second aspect of the invention 60 is disclosed, wherein the method may comprise:

a) performing 61 a purification cycle comprising: loading an amount of sample feed onto the column, washing the column and eluting the at least one captured product,

b) measuring 62 at least one parameter during the purification cycle indicative of breakthrough of the at least one captured product after the column during loading of the sample feed; and measuring 64 at an additional parameter during the purification cycle indicative of an amount of the at least one captured product after the column during eluting;

c) increasing 68a the amount of sample feed loaded during loading in the next purification cycle if the amount of the at least one captured product is declining without an indication of breakthrough, as indicated in 67; and

d) repeating steps a)-d).

According to some embodiment, the amount of sample feed in step c) is increased by 1%.

According to some embodiments, the method further comprising prior to step c) evaluating 65 the at least one additional parameter; and cleaning 65a the column if the purification capacity is below an upper predetermined threshold.

According to some embodiment, the evaluation is a trend analysis of the measured at least one additional parameter over time.

According to some embodiment, the additional parameter is an elution peak area measured when eluting the at least one captured product in relation to amount of sample feed loaded onto the column.

According to some embodiment, the step of evaluating the at least one additional parameter further comprises replacing 69 the column with a new column if the purification capacity is below the lower predetermined threshold mentioned above while break through is detected as indicated by 65b.

According to some embodiment, step c) further comprises reducing 66a the amount of sample feed loaded during loading in the next purification cycle if breakthrough of the at least one captured product is detected, as indicated by 66. According to some embodiments the amount of sample feed is reduced at least 5%. In some embodiments, the amount of sample feed is reduced not more than 10% when break through is detected.

According to some embodiment, the loading of the sample in step a) is performed during a loading time Δt; and the loading time is reduced in step c) to prevent break through during the next purification cycle.

According to some embodiment, the loading time is increased 68a for the next purification cycle when the loading time is maintained in step c) during at least “x” consecutive purification cycles, for instance 25 consecutive cycles as indicated by 68.

According to some embodiment, the measured parameter in step b) is a signal from a UV detector mounted after the column.

According to some embodiment, the cyclical repetitive purification is performed on a batch of sample feed, or on sample feed continuously provided from a cell culture reactor.

The invention also relates to a capture chromatography system comprising a column configured for purification performed on a sample feed comprising at least one product configured to be captured in the column during loading and a control unit configured to control purification in the column, wherein the control unit is further configured to perform the method described in connection with FIG. 6.

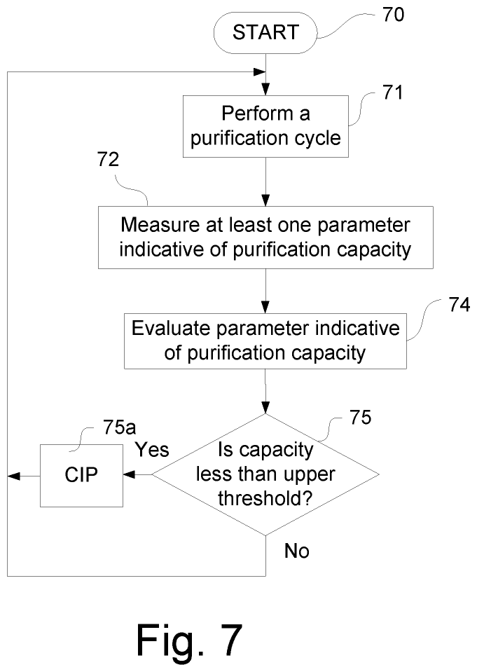

FIG. 7 illustrates a third aspect of a method for monitoring operational status in a column capture chromatography system configured for cyclical repetitive purification performed on a volume of sample feed comprising at least one product configured to be captured in the column during loading. The volume of sample feed originates from the same feed, e.g. a large batch or a continuous feed. The capture chromatography system comprises one single column, or alternatively several columns coupled in parallel, to which a bio reactor may be connected and configured to provide a volume of sample feed to the column, wherein the volume of sample feed is larger than the volume capacity of the capture chromatography system. Thus requiring a cyclic purification in a repetitive manner. The process comprises a number of steps:

a) performing 71 a purification cycle comprising: loading of an amount of sample feed onto the column, washing the column and eluting the at least one captured product;

b) measuring 72 at least one parameter during elution of the at least one captured product indicative of purification capacity in the chromatography system;

c) evaluating 74 the at least one parameter; and cleaning 75a the column if the purification capacity is lower than an upper predetermined threshold; and

d) repeating steps a)-d).

According to some embodiments, the at least one parameter in step b) is selected to be amount of eluted product in relation to amount of sample feed loaded onto the column. According to some embodiments, the at least one parameter in step b) is selected to be titer and the method further comprises determining peak area during elution and estimating titer based on the determined peak area.

According to some embodiments, the cyclical repetitive purification is performed on a batch of sample feed, or on sample feed continuously provided from a cell culture reactor.

The invention also relates to a capture chromatography system comprising a column configured for cyclical repetitive purification performed on an amount of sample feed comprising at least one product and a control unit configured to control purification in the column, wherein the control unit is further configured to perform the method described in connection with FIG. 7.

The methods described above may be implemented in a computer program for controlling a bioprocess purification system. The computer program comprises instructions which, when executed on at least one processor, cause the at least one processor to carry out the method according to the methods described in connection with FIGS. 5-7. The computer program for controlling the bioprocess purification system may be stored on and carried by a computer readable storage medium.

Various aspects and embodiments of the present invention may thus provide a process for running a first chromatography column without manual intervention (e.g. automatically), and only switching to the use of another chromatography column should the first become exhausted.

1. A method for monitoring operational status in a column capture chromatography system configured for cyclical repetitive purification performed on a volume of sample feed comprising at least one product configured to be captured in the column during loading, wherein the method comprises:
a) performing a purification cycle comprising: loading an amount of sample feed onto the column, washing the column and eluting the at least one captured product,
b) measuring at least one parameter during the purification cycle indicative of breakthrough of the at least one captured product after the column during loading of sample feed;
c) reducing the amount of sample feed loaded during loading in the next purification cycle if breakthrough of the at least one captured product is detected; and
d) repeating steps a)-c).

2. The method according to claim 1, wherein loading of the sample in step a) is performed during a loading time; and the loading time is reduced in step c) to prevent break through during the next purification cycle.

3. The method according to claim 2, wherein the loading time is increased for the next purification cycle when the loading time is maintained in step c) during a predetermined number of consecutive purification cycles.

4. The method according claim 1, wherein the measured parameter in step b) is a signal from a UV detector mounted after the column.

5. The method according to claim 1, wherein the method further comprises monitoring at least one additional parameter measured during elution of the at least one captured product indicative of purification capacity of the column and increasing the amount of sample feed loaded during loading in the next purification cycle if the purification capacity is declining without an indication of breakthrough.

6. The method according to claim 5, further comprising prior to step c) evaluating the at least one additional parameter; and cleaning the column if the purification capacity is below an upper predetermined threshold.

7. The method according to claim 6, wherein the evaluation is a trend analysis of the measured at least one additional parameter over time.

8. The method according to claim 7, wherein the additional parameter is an elution peak area measured when eluting the at least one captured product in relation to amount of sample feed loaded onto the column.

9. The method according to claim 6, wherein the step of evaluating the at least one additional parameter further comprises replacing the column with a new column if the purification capacity is below a lower predetermined threshold while break through is detected.

10. The method according to claim 1, wherein the cyclical repetitive purification is performed on a batch of sample feed, or on sample feed continuously provided from a cell culture reactor.

11. A method for monitoring operational status in a column capture chromatography system configured for cyclical repetitive purification performed on a volume of sample feed comprising at least one product configured to be captured in the column during loading, wherein the method comprising:
a) performing a purification cycle comprising: loading an amount of sample feed onto the column, washing the column and eluting the at least one captured product,
b) measuring at least one parameter during the purification cycle indicative of breakthrough of the at least one captured product after the column during loading of the sample feed; and measuring at an additional parameter during the purification cycle indicative of an amount of the at least one captured product after the column during eluting;
c) increasing the amount of sample feed loaded during loading in the next purification cycle if the amount of the at least one captured product is declining without an indication of break through; and
d) repeating steps a)-c).

12. The method according to claim 11, further comprising prior to step c) evaluating the at least one additional parameter; and cleaning the column if the purification capacity is below an upper predetermined threshold.

13. The method according to claim 12, wherein the evaluation is a trend analysis of the measured at least one additional parameter over time.

14. The method according to claim 13, wherein the additional parameter is an elution peak area measured when eluting the at least one captured product in relation to amount of sample feed loaded onto the column.

15. The method according to claim 11, wherein the step of evaluating the at least one additional parameter further comprises replacing the column with a new column if the purification capacity is below a lower predetermined threshold while break through is detected.

16. The method according to, wherein step c) further comprises reducing the amount of sample feed loaded during loading in the next purification cycle if breakthrough of the at least one captured product is detected.

17. The method according to claim 16, wherein loading of the sample in step a) is performed during a loading time; and the loading time is reduced in step c) to prevent break through during the next purification cycle.

18. The method according to claim 17, wherein the loading time is increased for the next purification cycle when the loading time is maintained in step c) during at least 25 consecutive purification cycles.

19. The method according to claim 11, wherein the measured parameter in step b) is a signal from a UV detector mounted after the column.

20. The method according to claim 11, wherein the cyclical repetitive purification is performed on a batch of sample feed, or on sample feed continuously provided from a cell culture reactor.

21. A method for monitoring operational status in a column capture chromatography system configured for cyclical repetitive purification performed on a volume of sample feed comprising at least one product configured to be captured in the column during loading, wherein the method comprising:
a) performing a purification cycle comprising: loading an amount of sample feed onto the column, washing the column and eluting the at least one captured product;
b) measuring at least one parameter during elution of the at least one captured product indicative of purification capacity in the chromatography system;
c) evaluating the at least one parameter; and cleaning the column if the purification capacity is lower than an upper predetermined threshold; and
d) repeating steps a)-c).

22. The method according to claim 21, wherein the at least one parameter is selected to be amount of eluted at least one product in relation to the amount of sample feed loaded onto the column.

23. The method according to claim 21, wherein the at least one parameter is selected to be titer and the method further comprises determining peak area during elution and estimating titer based on the determined peak area.

24. The method according to claim 21, wherein the cyclical repetitive purification is performed on a batch of sample feed, or on sample feed continuously provided from a cell culture reactor.

25. A capture chromatography system comprising a column configured for cyclical repetitive purification performed on a volume of sample feed comprising at least one product and a control unit configured to control purification in the column, wherein the control unit is further configured to perform the method according to claim 1.

26. A capture chromatography system comprising a column configured for cyclical repetitive purification performed on a volume of sample feed comprising at least one product and a control unit configured to control purification in the column, wherein the control unit is further configured to perform the method according to claim 21.

27. A computer program for monitoring operational status in a column chromatography system, comprising instructions which, when executed on at least one processor, cause the at least one processor to carry out the method according to claim 1.

28. A computer-readable storage medium carrying a computer program for monitoring operational status in a column chromatography system according to claim 27.
